(19) United States
(12) Patent Application Publication
(10) Pub. No.: US 2008/0133803 A1
(43) Pub. Date: Jun. 5, 2008

(54) USB KEYBOARD WITH REMOVABLE USB KEYBOARD WIRE

(75) Inventors: CHANG-CHUN LIU, Shenzhen (CN); XIAO-LIN GAN, Shenzhen (CN); YU-KUANG HO, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/828,357

(22) Filed: Jul. 26, 2007

(30) Foreign Application Priority Data
Dec. 5, 2006 (CN) 200610201216.X

(51) Int. Cl. G06F 13/00

(52) U.S. Cl. 710/64

(57) ABSTRACT

A universal serial bus (USB) keyboard includes a keyboard main body and a USB keyboard wire. The keyboard main body includes a USB interface and a plurality of keys for inputting data. The USB keyboard wire includes a first USB connector configured for connecting to a USB interface of a computer, and a second USB connector configured for connecting to the USB interface of the keyboard main body to thereby communicate the keyboard main body with the computer.

### BACKGROUND OF THE INVENTION

1. Field of the Invention

The present invention relates to keyboards, and particularly to a universal serial bus (USB) keyboard.

2. Description of Related Art

Generally speaking, the conventional USB keyboard has a built-in processor connected to the CPU of the computer through a USB connector. The USB connector is connected to the USB keyboard via a USB keyboard wire, which is fastened on the USB keyboard. The keyboard wire cannot be separated from the keyboard. When the USB keyboard is not in use and put aside, the USB keyboard wire may be wrapped around the keyboard or occupy some other space, which is inconvenient.

What is desired, therefore, is to provide a USB keyboard which overcomes the above problems.

### SUMMARY OF THE INVENTION

An exemplary universal serial bus (USB) keyboard includes a keyboard main body and a USB keyboard wire. The keyboard main body includes a USB interface and a plurality of keys for inputting data. The USB keyboard wire includes a first USB connector configured for connecting to a USB interface of a computer, and a second USB connector configured for connecting to the USB interface of the keyboard main body to thereby communicate the keyboard main body with the computer.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an exploded, schematic view of a USB keyboard in accordance with a first embodiment of the present invention;

FIG. 2 is an assembled view of FIG. 1; and

FIG. 3 is an assembled view of a USB keyboard in accordance with a second embodiment of the present invention.

### DETAILED DESCRIPTION OF THE INVENTION

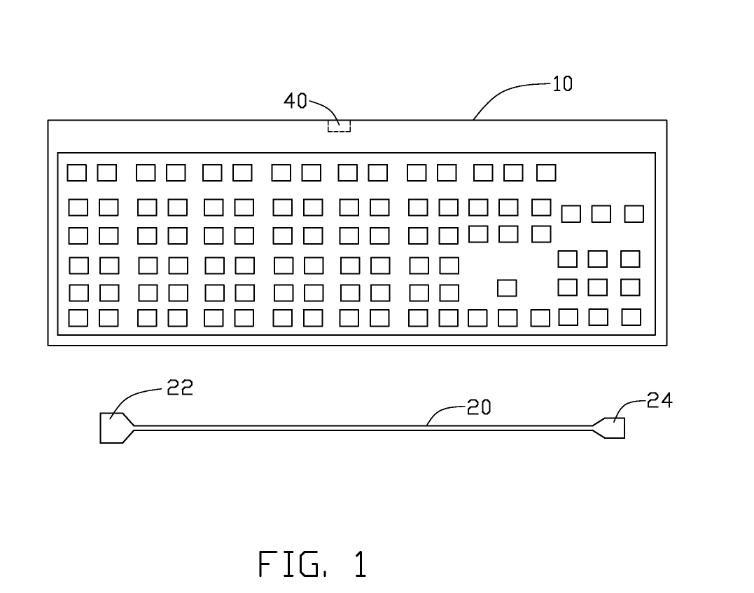

Referring to FIG. 1, a USB keyboard in accordance with a first embodiment of the present invention includes a keyboard main body 10 and a USB keyboard wire 20. The keyboard main body 10 includes a USB interface 40 and a plurality of keys, such as 104 keys, for data input. The USB interface 40 can be defined in any suitable place of the keyboard main body 10, for example, in this embodiment, the USB interface 40 is defined in a rear side of the keyboard main body 10. The USB keyboard wire 20 includes a first USB connector 22 and a second USB connector 24. In this embodiment, the first USB connector 22 is a general USB connector, and the second USB connector 24 is a mini USB connector.

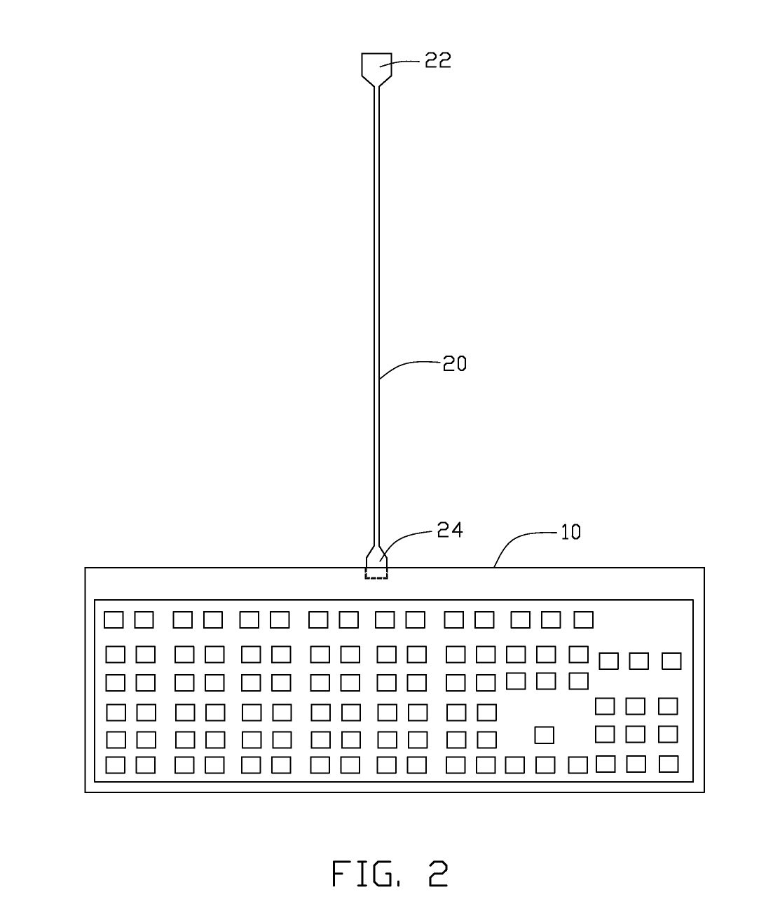

Referring also to FIG. 2, when using the USB keyboard, the second USB connector 24 of the USB keyboard wire 20 is connected to the USB interface 40 of the keyboard main body 10. The first USB connector 22 of the USB keyboard wire 20 is connected to a USB interface of a computer (not shown).

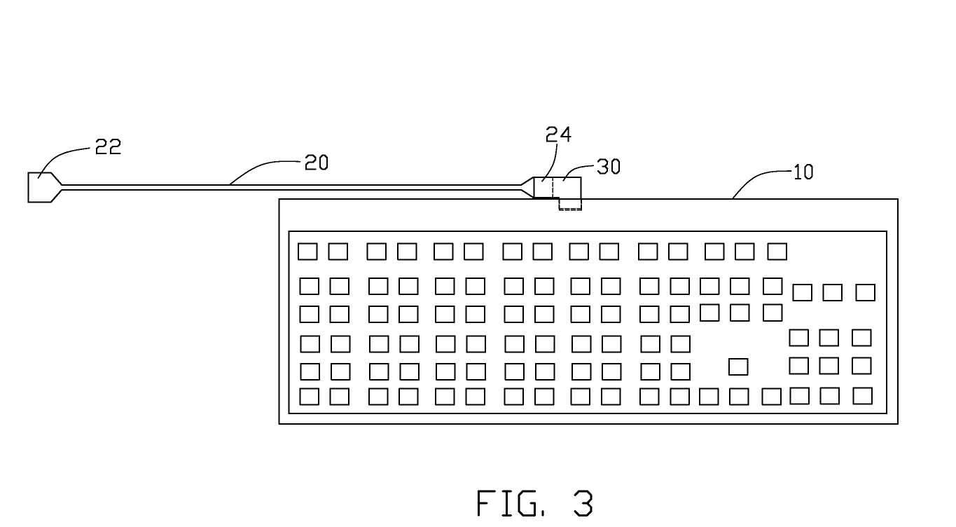

Referring also to FIG. 3, a USB keyboard in accordance with a second embodiment of the present invention is shown. The second embodiment is similar to the first embodiment, except that the second embodiment further includes an L-shaped adapter 30 for allowing connection of the wire 20 to the keyboard 10 from another angle, which may save space or be more convenient. The L-shaped adapter 30 includes a first USB connector and a second USB connector defined at opposite ends thereof. When using the USB keyboard, the second USB connector 24 of the USB keyboard wire 20 is connected to one of the USB connectors of the L-shaped adapter 30. The other one of the USB connectors 24 of the L-shaped adapter 30 is connected to the interface 40 of the keyboard main body 10. The first USB connector 22 of the USB keyboard wire 20 is connected to a USB interface of a computer.

The USB keyboard of the embodiments allow convenient removal or disconnection of the USB keyboard wire 20 from the keyboard main body 10 when not in use, and then the USB keyboard wire 20 can be used to directly connect with other USB devices, such as external hard disk drives, digital cameras, etc, to communicate with the computer which can save on the number of USB wires needed. Furthermore, the keyboard main body 10 and the USB keyboard wire 20 can be stored separately, which can be more convenient.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A universal serial bus (USB) keyboard comprising:
a keyboard main body comprising a USB interface and a plurality of keys for inputting data; and
a USB keyboard wire comprising a first USB connector configured for connecting to a USB interface of a computer, and a second USB connector configured for connecting to the USB interface of the keyboard main body to thereby communicate the keyboard main body with the computer.

2. The USB keyboard as claimed in claim 1, wherein the USB interface is defined in a rear side of the keyboard main body.

3. The USB keyboard as claimed in claim 1, wherein the first USB connector is a general USB connector, and the second USB connector is a mini USB connector.

4. The USB keyboard as claimed in claim 1, further comprising an L-shaped adapter, wherein the L-shaped adapter includes a first USB connector configured for connecting to the second connector of the USB keyboard wire in one direction, and a second USB connector configured for connecting to the USB interface of the keyboard main body in another one direction perpendicular to said one direction.
